(19) United States
(12) Patent Application Publication
(10) Pub. No.: US 2026/0163601 A1
(43) Pub. Date: Jun. 11, 2026

(54) Joint Having Electrical Power Connection and Wireless Communication

(71) Applicant: Agility Robotics, Inc., Pittsburgh, PA (US)

(72) Inventors: Elise Fermier, Newport, OR (US); Jim Coy, Albany, OR (US); Ryan Domres, Albany, OR (US)

(21) Appl. No.: 19/043,284

(22) Filed: Jan. 31, 2025

Related U.S. Application Data
(60) Provisional application No. 63/730,051, filed on Dec. 10, 2024.

(51) Int. Cl. H04B 1/40; G01S 5/02; H01Q 1/22; H04B 10/40

(52) U.S. Cl. CPC H04B 1/40; G01S 5/0284; H04B 10/40; H01Q 1/225

(57) ABSTRACT

A joint supporting wireless communication includes a first structure having an attached first wireless transceiver and a second structure having an attached second wireless transceiver. The first and second structures are arranged to maintain electrical contact during rotation or other movements. In some embodiments, the first and second wireless transceivers can be RF transceivers or optical transceivers. In some embodiments, the first and second structures define at least a part of a mobile humanoid robot.

### RELATED APPLICATION

The present disclosure is part of a non-provisional patent application claiming the priority benefit of U.S. Patent Application No. 63/730,051, filed on Dec. 10, 2024, which is hereby incorporated by reference in its entirety.

### TECHNICAL FIELD

The present technology relates to mechanical and electrical systems supporting wireless data transfer in rotary, telescoping, or other joints suitable for robotic applications.

### BACKGROUND

Transfer of both power and high speed data across electromechanical joints (hereinafter, also referred to as “joints”) is of increasing importance for a range of industrial and robotic applications. In many conventional designs, multiple electrical and/or optical cables are used for both electrical power and communication across or through a joint.

Unfortunately, using multiple cables in a joint comes with significant disadvantages. For example, flexing or twisting cables can reduce their effective lifetime due to cable fatigue. Cable routing through or around a joint can complicate assembly, and cable routing across a joint complicates swapping components and servicing. Most importantly, for many applications, cable routing through rotary joints can prevent continuous rotation due to, for example, the associated wiring harness and/or cable assembly twisting and winding around itself.

Small, lightweight, durable, and reliable connections for transferring power and high speed data across rotary, telescoping, or other joint types are needed. Ideally, such connections will support multiple communication channels and/or one or more power connections.

### SUMMARY

Disclosed herein are embodiments for a joint supporting electrical power connection and wireless communication. The joint has a first structure having an attached first wireless transceiver and a second structure having an attached second wireless transceiver connectable with the first wireless transceiver. At least one electrical contact is positioned in a manner that physically connects the first and second structures to allow electrical power to be transferred between the first and second structures. The first and second structures are movable with respect to each other.

In some embodiments, a rotating bore is attached to one of the first and second structures, with the first and second wireless transceivers respectively positioned to allow wireless transmission through the rotating bore.

In some embodiments, at least one electrical contact can be a roll ring.

In some embodiments, the first and second wireless transceivers are RF transceivers.

In some embodiments, the first and second wireless transceivers are optical transceivers.

In some embodiments, the first and second wireless transceivers are RF transceivers that together act as position sensors by using RF measurements to determine relative angle between the first and second wireless transceivers.

In some embodiments, the first and second structures define at least a part of a robotic arm.

In some embodiments, the first and second structures define at least a part of a mobile humanoid robot.

In another embodiment, a humanoid robot includes a joint supporting wireless communication. The joint has first structure having an attached first wireless transceiver and a second structure having an attached second wireless transceiver connectable with the first wireless transceiver. The first and second structures are movable with respect to each other and define a portion of a mobile humanoid robot.

In another embodiment, a rotary joint supporting electrical power connection and wireless communication includes a first structure having an attached first wireless transceiver and a second structure having an attached second wireless transceiver connectable with the first wireless transceiver. At least one electrical contact is positioned in a manner that physically connects the first and second structures to allow electrical power to be transferred between the first and second structures. In one embodiment, the first and second structures are rotatable with respect to each other.

In another embodiment, a method for determining rotational angle for a rotary joint supporting wireless RF communication includes associating first and second RF transceivers respectively positioned on mechanically connected first and second structures that can rotate relative to each other. RF signals can be measured as the first and second structures are rotated with respect to each other, and rotational position based on measured RF signals is determined.

### BRIEF DESCRIPTION OF THE DRAWINGS

Certain aspects of the present technology can be better understood with reference to the following drawings. The relative dimensions in the drawings may be to scale with respect to some embodiments of the present technology. With respect to other embodiments, the drawings may not be to scale. The drawings may also be enlarged arbitrarily. For clarity, reference-number labels for analogous components or features may be omitted when the appropriate reference-number labels for such analogous components or features are clear in the context of the specification and all of the drawings considered together. Furthermore, the same reference numbers may be used to identify analogous components or features in multiple described embodiments.

FIG. 1 is a simplified cross-sectional view of a rotary joint having structures that support wireless communication in accordance with at least some embodiments of the present technology.

FIG. 2 illustrates a method of determining degree or speed of relative rotation between the external housing structure and the bore housing.

FIG. 3 is a cross-sectional perspective view of a rotary joint with roll rings for power transfer and supporting both wireless and optical communication.

FIG. 4A illustrates a circular array of respective transmit and receive patch antennas configured to measure degree of mechanical rotation.

FIG. 4B illustrates a rectangular array of beamforming enabled antennas configured to measure degree of mechanical rotation.

FIG. 5 is a perspective view of a mobile robot with multiple rotary joints that support wireless communication in accordance with at least some embodiments of the present invention.

FIG. 6 is a block diagram illustrating an electrical and computer system of a mobile robot such as illustrated in FIG. 5.

### DETAILED DESCRIPTION

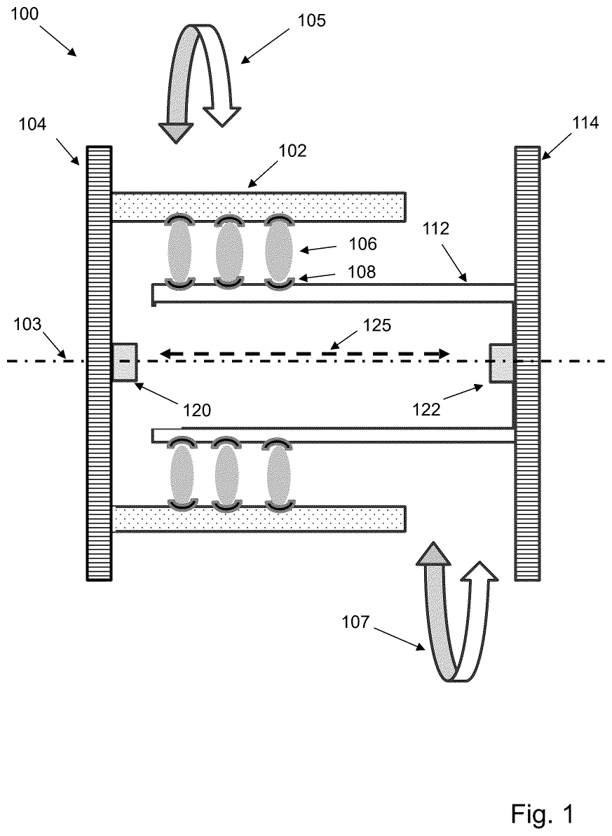

FIG. 1 is a simplified cross-sectional view of a rotary joint 100 having structures that support wireless communication in accordance with at least some embodiments of the present technology. The rotary joint 100 (i.e. a revolute joint) is a type of joint capable of rotating around a single axis of rotation (e.g. line 103). In this embodiment, the rotary joint 100 supports both electrical power transfer and wireless communication. In some embodiments, continuous or partial rotation of the rotary joint 100 can be allowed in either a clockwise or a counterclockwise direction with respect to line 103. As illustrated, the rotary joint 100 has an external housing 102 and a bore housing 112. The external housing 102 has an attached plate 104 and the bore housing 112 has an attached plate 114. The external housing 102 at least partially surrounds the bore housing 112. In this embodiment, both the external housing 102 and the bore housing 112 have a generally cylindrical shape, and the bore housing 112 is sized to at least partially fit inside the external housing 102.

Both the external housing 102 and the bore housing 112 can move by rotation (arrows 105 and 107) with respect to each other using rolling rings 106 or other suitable sliding or rolling components. In an embodiment, an individual rotation of the external housing 102 and the bore housing 112 is about an axis that is substantially coincident with line 103. In other words, arrows 105 and 107 define the rotational motion of housing 102 and bore housing 112, and hence the (relative) rotational motion of rotary joint 100, about line 103. The rolling rings 106 are constrained to roll within roll ring contact tracks 108 defined or attached to the respective external housing 102 and the bore housing 112.

In one aspect, rolling rings 106 may be configured to move in a rolling motion when the external housing 102 and the bore housing 112 engage in rotational motion with respect to each other about line 103. The rolling motion of rolling rings 106 generally reduces contact friction between moving contact surfaces between the external housing 102 and rolling rings 106 (via roll ring contact tracks 108), and between the bore housing 112 and rolling rings 106 (via roll ring contact tracks 108). This reduction in contact friction is associated with rolling friction, as preferred over static or dynamic friction. At the same time, rolling rings 106 maintain physical continuous contact with the external housing 102 and the bore housing 112 through the associated rolling motion where at least one portion of rolling rings 106 is in physical contact with the external housing 102, and at least another portion of rolling rings 106 is in physical contact with the bore housing 112. This physical contact ensures substantially continuous electrical contact between the external housing 102 and the bore housing 112. Coaxial alignment of the external housing 102 and bore

housing 112 about line 103 is maintained by bearings that are not shown for the sake of clarity.

In operation, the rolling rings 106 can function as electrical power connections between the external housing 102 and the bore housing 112, due to the continuous electrical contact described above. More generally, electrical power is provided in a manner that physically connects and allows for transfer of electrical power or data between the external housing 102 and bore housing 112, even when the external housing 102 and bore housing 112 are movable by rotation with respect to each other. This is achieved via the rolling rings 106 as described above. In an aspect, rolling rings 106 are constructed of electrically conductive material, to enable the associated electrical power connections between the external housing 102 and the bore housing 112.

Advantageously, the rotary joint 100 such as described and claimed herein can be used in any electromechanical system that requires rotation while transmitting power or signals. It can improve mechanical performance, simplify system operation, and eliminate easily damaged wires from movable joints. Also called rotary electrical interfaces, rotating electrical connectors, collectors, swivels, or electrical rotary joints, the rotary joint allows transmission of power and electrical signals from a stationary or rotatable structure to another stationary or rotating structure. Rolling or slip rings used in such rotary joints are alternatively called collector rings, rotary electrical contacts, and/or rolling contact rings.

As will be understood, other types of joints than rotary joints can be used in accordance with the described embodiments. This can include, but is not limited to, telescoping, linear, or prismatic joints where one or both sides of a joint can move or extend with respect to each other. Other types of joints that permit movement of structures with respect to each other while potentially maintaining mechanical and electrical power connection can include spherical joints, ball and socket joints, universal or cardan joints, cylindrical joints, slider joints, or planar joints.

In one embodiment, data can also be transferred between the external housing 102 structure and the bore housing 112 with a first wireless transceiver 120 supported by plate 104 that can communicate with a second wireless transceiver 122 supported by plate 114. In some embodiments, the first and second wireless transceivers 120 and 122 can be positioned on a central bore line 125 on or near the single axis of rotation (line 103) to better maintain communication between the first and second wireless transceivers 120 and 122 during rotation.

In one embodiment, the first and second wireless transceivers 120 and 122 can include receivers and transmitters that rely on electromagnetic based pulse or carrier modulation to transfer data. These can include but are not limited to radiofrequency (RF) systems such as Wi-Fi, Zigbee, wireless HDMI, Bluetooth, or other short range RF protocols. In some embodiments, security can also be increased through use of spectrum hopping and/or encryption.

In other embodiments, the first and second wireless transceivers 120 and 122 can include receivers and transmitters that rely on optical or laser signaling to transfer data. These can include but are not limited to LiFi or other free space optical systems based on modulated optical or infrared LED or laser devices. In some embodiments the bore housing 112 and/or frame can form or be equipped with optical shielding to reduce transceiver signal noise and limit external optical emission.

As will be understood, in other embodiments various other electromagnetic coupling systems including optical, RF, capacitive, or an inductive physical coupling medium can be used. All these forms of electromagnetic coupling should be able to wirelessly transmit and receive data, and in some embodiments also allow sensing of relative positions. Multiple types of same or different wireless transceivers can be used together to improve communication data capacity or allow for backup, redundant, or emergency communication.

As will be understood, wireless communication and mechanical joint performance can be improved by wholly or partially sealing the external housing 102, bore housing 112, or other components of the rotary joint 100. Sealing can reduce or eliminate interfering dust or debris from entering into the space between the external housing 102 and the bore housing 112. Depending on light or electromagnetic blocking requirements, a choice of materials used can significantly reduce emissions associated with wireless communication. This can benefit applications that need to reduce one or both of external or internal communication interference. For example, the bore housing 112 can have or be equipped with metallic or conductive RF shielding to reduce transceiver signal noise and limit external RF emission. Such RF shielding can reduce potential RF interference within the machine or robot, or in nearby machines or other robots.

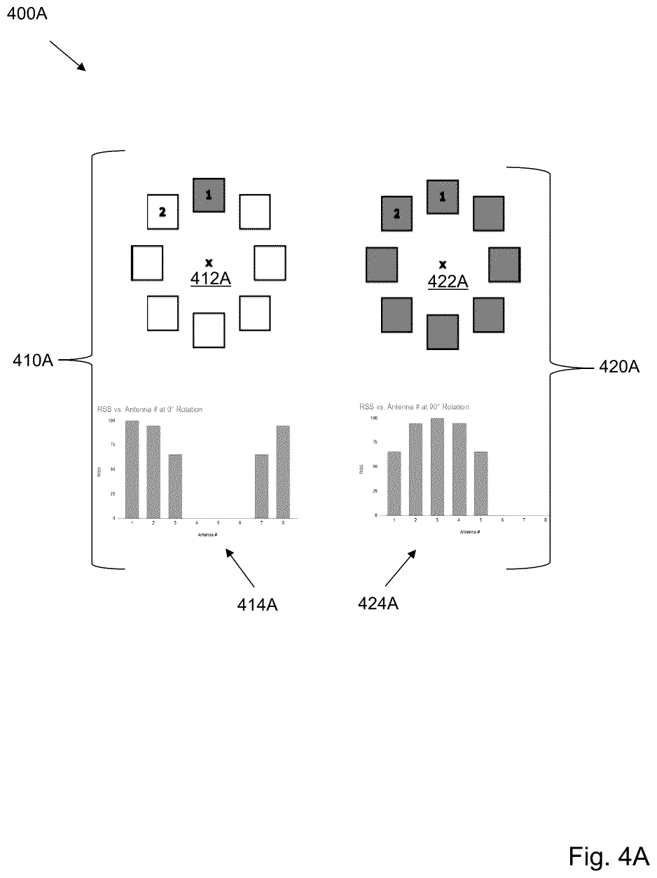

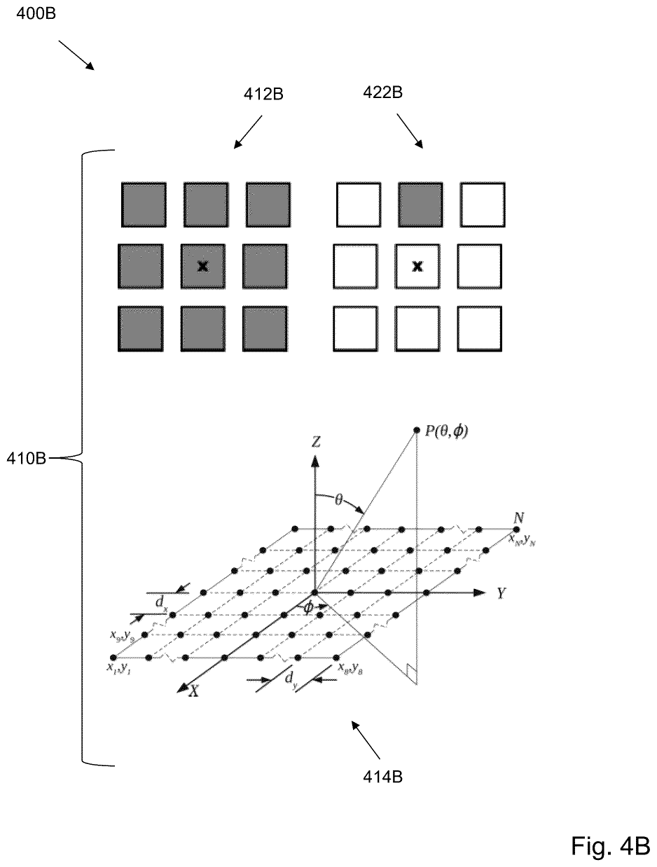

In some embodiments, rotational degree or speed of relative rotation between the external housing 102 and the bore housing 112 can be determined by use of a radiofrequency (RF) antenna array associated with the first and second wireless transceivers 120 and 122, that is able to measure anisotropic response patterns. In some embodiments, this can involve measuring two dimensional electromagnetic response patterns or measuring simple received signal strength, such as is later discussed with respect to FIG. 4A. In some embodiments, a beam-forming array can be used to track an off-axis antenna to determine rotational degree or speed of relative rotation between the external housing 102 and the bore housing 112, such as is later discussed with respect to FIG. 4B.

In some embodiments, rotational degree or speed of relative rotation between the external housing 102 and the bore housing 112 can be determined by use of one or more anisotropic optical measurements of polarization, light intensity, or light patterning associated with the first and second wireless transceivers 120 and 122.

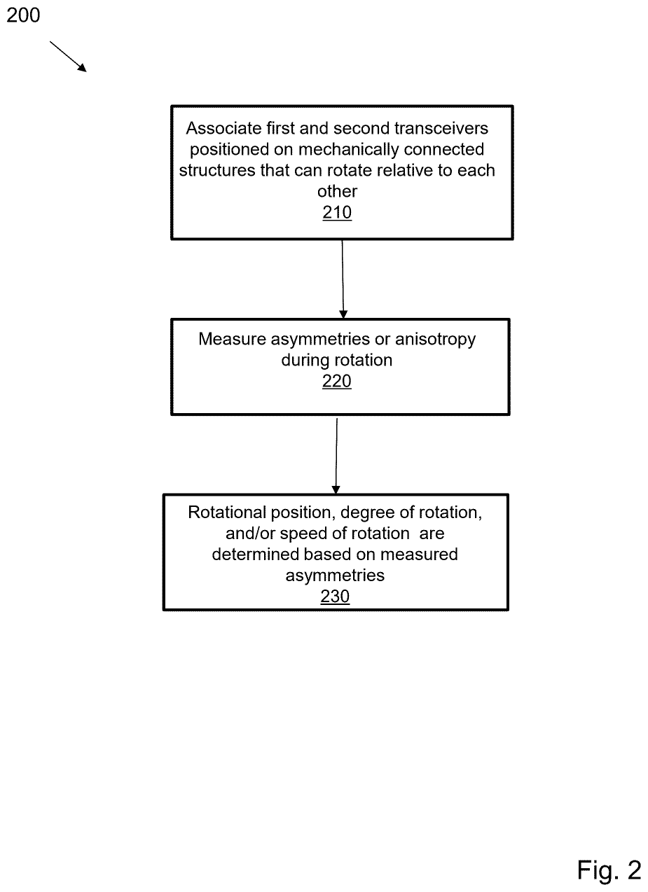

FIG. 2 illustrates a method 200 of determining degree and speed of relative rotation between the external housing 102 and the bore housing 112 of FIG. 1. In a first step 210, first and second transceivers (e.g., first and second wireless transceivers 120 and 122, respectively) positioned on structures that can rotate relative to each other (e.g., the external housing 102 and the bore housing 112) are associated to allow one-or two-way communication. In step 220, one or more asymmetries or detectable anisotropy caused by rotation are measured during the rotation. In step 230, rotational position, degree of rotation, and/or speed of rotation are determined based on measured asymmetries and/or anisotropy.

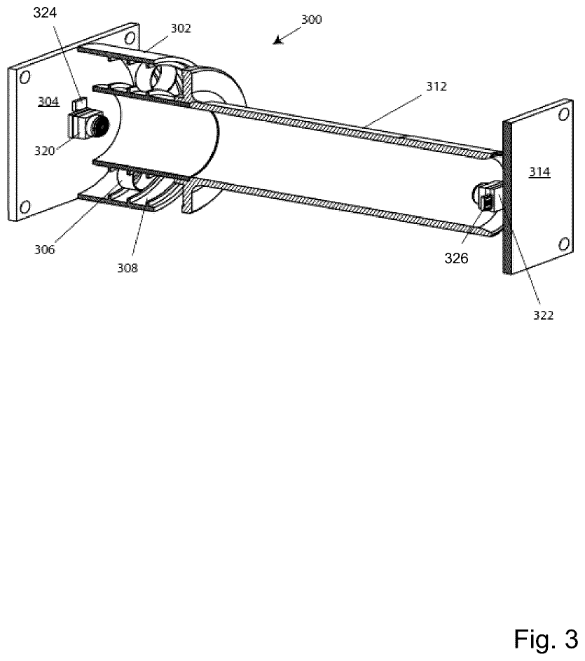

FIG. 3 is a cross-sectional perspective view of a rotary joint 300 with roll rings 306 (similar to rolling rings 106) contained within roll ring contact tracks 308 (similar to roll ring contact tracks 108) that allow for electrical power transfer. In this embodiment, the rotary joint 300 supports wireless communication across or along the joint. In some embodiments, continuous or partial rotation of the rotary joint 300 can be allowed in either clockwise or counterclockwise direction with respect to an axis of rotation (similar to line 103). As illustrated, an external housing 302 (similar to the external housing 102) has an attached plate 304 (similar to the plate 104) and at least partially surrounds a bore housing 312 (similar to the bore housing 112). The bore housing 312 is attached to a plate 314 (similar to the plate 114). Both the external housing 302 and the bore housing 312 can rotate with respect to each other using roll rings 306 or other suitable sliding or rolling components (e.g. slip rings) that work as electrical contacts between the external housing 302 structure and the bore housing 312 structure. This electrical contact connection allows for transfer of electrical power or data between external housing 302 and bore housing 312. In this embodiment, wireless communication across or along the rotary joint 300 is respectively supported by first wireless optical transceiver 320 supported by plate 304 that can communicate with a second wireless optical transceiver 322 supported by plate 314. Additionally, wireless communication across or along the rotary joint 300 is respectively supported by first wireless radiofrequency (RF) transceiver 324 supported by plate 304 that can communicate with a second wireless RF transceiver 326 supported by plate 314. Collectively, first wireless optical transceiver 320 and first wireless radiofrequency transceiver 324 are similar to first wireless transceiver 120; second wireless optical transceiver 322 and second wireless radiofrequency transceiver 326 are collectively similar to second wireless transceiver 122.

FIG. 4A illustrates a system 400A of respective transmit patch antennas 410A (with associated received signal strength at 0 degrees rotation shown by graph 414A) and receive patch antennas 420A (with associated received signal strength at 90 degrees rotation shown by graph 424A) configured to measure degree of mechanical rotation in a rotary joint (e.g., rotary joint 100). In this embodiment, anisotropic response patterns based on received signal strengths allow for sensing relative rotation. As illustrated, patch antennas 410A are distributed in a circular layout around a “x” indicated point 412A, while patch antennas 420A are distributed in a circular layout around a “x” indicated point 422A. Patch antennas 410A and 420A can face each other and coaxially rotate with respect to each other on a rotational axis (not illustrated) extending between points 412A and 422A. In an aspect, this rotational axis may be similar to or substantially parallel to line 103. Each individual antenna can be identified and connected with an RF interface that is able to isolate and measure received signal strength (RSS) for each of the patch antennas 410A and 420A. In operation, these two patch antenna arrays 410A and 420A face each other and rotate coaxially around the “x” marked points 412A and 422A. Such rotation may be observed when patch antenna arrays 410A and 422A are a part of first and second wireless transceivers 120 and 122 respectively, and when the external housing 102 and the bore housing 112 are rotating relative to each other. By transmitting and comparing received signal strength at different rotational positions (one example being seen in charts 414A and 424A) as the two arrays rotate with respect to each other, signal strength response patterns can provide a relative mechanical angle of rotation.

As will be appreciated, in other embodiments, the described RF wireless coupling based system 400A can be replaced with a capacitive or inductive based wireless system. In such an embodiment, a response pattern or received signal strength method can be used in a manner similar to that discussed with respect to system 400A, with capacitive or inductive based techniques substituting for RF coupling. In some embodiments, because capacitive/inductive coupling works over much shorter distances than RF, the position(s) of the transceivers can be adjusted to reduce their separation.

FIG. 4B illustrates a system 400B of rectangular arrays 410B of beamforming enabled antennas (412B and 422B) configured to measure degree of mechanical rotation. In some embodiments, a beam-forming array can be used to track an off-axis antenna on the receive side. Rather than comparing RSS between antennas, the full array (indicated as the fully darkened patch antennas in array 412B), is configured for transmit, and beam-forms its output to maximize received signal strength on a single offset antenna (indicated as the single darkened patch antenna in array 422B), allowing tracking of the mechanical angle of rotation of patch antenna array and its associated structural rotation. An example of such a rotation is illustrated with respect to a generic representation 414B showing beamforming by multiple antennas, toward a three dimensional point P. In operation, the determined angle φ needed track a particular patch antenna would correlate with a degree of mechanical rotation of that patch antenna. The associated beam-forming angle can then be correlated with the corresponding joint angle. A time-series of angular measurements sampled over a period of time can be differentiated with respect to time to obtain a series of angular speed data associated with the rotation. In this way, the degree of rotation and a corresponding relative angular speed between the external housing 102 and the bore housing 112 as associated with rotary joint 100 can be measured.

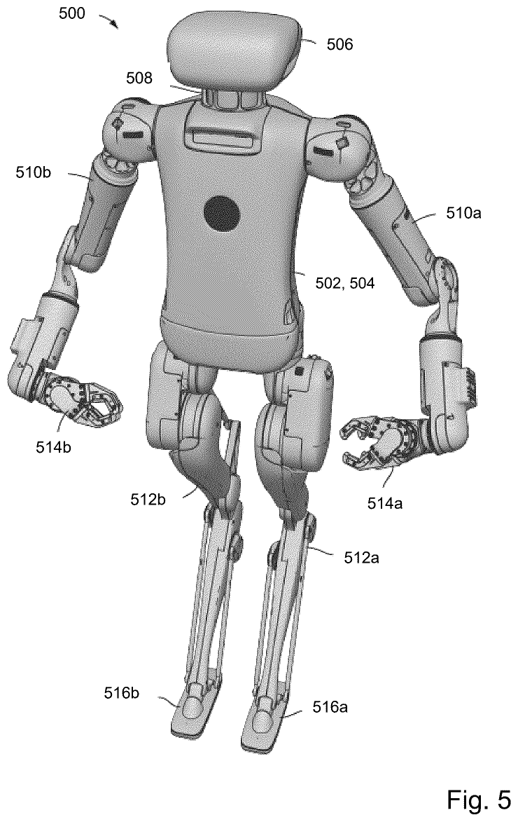

FIG. 5 is a perspective view of a mobile robot with multiple rotary joints that support wireless communication in accordance with at least some embodiments of the present. As shown in FIG. 5, the mobile robot 500 can be configured to appear humanoid, with structures resembling human anatomy with respect to the features, positions, or other characteristics of such structures. In at least some cases, the mobile robot 500 defines a midsagittal plane about which the mobile robot 500 is bilaterally symmetrical. In these and other cases, the mobile robot 500 can be configured for bipedal locomotion similar to that of a human. Counterparts of the mobile robot 500 can have other suitable forms and features. For example, counterpart of the mobile robot 500 can have a non-humanoid form, such as a canine form, an insectoid form, an arachnoid form, or a form with no animal analog. Furthermore, a counterpart of the mobile robot 500 can be asymmetrical or have symmetry other than bilateral. Still further, a counterpart of the mobile robot 500 can be configured for non-bipedal locomotion. For example, a counterpart of the mobile robot 500 can be configured for another type of legged locomotion (e.g., quadrupedal locomotion, hexapedal locomotion, octopedal locomotion, etc.) or non-legged locomotion (e.g., wheeled locomotion, continuous-track locomotion, etc.).

With reference again to FIG. 5, the mobile robot 500 can include a centrally disposed body 502 through which other structures of the mobile robot 500 are interconnected. As all or a portion of the body 502, the mobile robot 500 can include a torso 504. The mobile robot 500 can further include a head 506 superiorly spaced apart from the torso 504. The mobile robot 500 can also include a neck 508 through which the head 506 is connected to the torso 504 via a superior portion of the torso 504. The mobile robot 500 can further include articulated appendages carried by the torso 504. Among these articulated appendages, the mobile robot 500 can include arms 510 (individually identified as arms 510a, 510b) and legs 512 (individually identified as legs 512a, 512b). At individual articulations of the arms 510a, 510b and legs 512a, 512b, the mobile robot 500 can include a joint and a corresponding actuator, such as a rotary actuator with a motor and gearing (e.g., cycloidal gearing or strain-wave gearing). In an aspect, the rotary actuator(s) used to implement motion at one or more joints associated with mobile robot 500 include the angular measurement system as described above for rotary joint 100. Such an implementation allows for the measurement of a degree of rotation and an angular speed of a joint. Such measurements can, for example, be used to generate feedback data for a feedback control system that governs the motion of the mobile robot 500.

In at least some cases, the mobile robot 500 is configured to manipulate objects via the arms 510a, 510b, such as bimanually. In these and other cases, the mobile robot 500 can be configured to bipedally ambulate via the legs 512a and 512b. Thus, the mobile robot 500 can be bimanual and bipedal. The arms 510a, 510b and the legs 512a, 512b can separately extend from the body 502 and define kinematic chains. In at least some cases, the kinematic chains corresponding to the arms 510a, 510b provide at least five degrees of freedom, such as exactly five or exactly six degrees of freedom. In these and other cases, the kinematic chains corresponding to the legs 512a, 512b can provide at least four degrees of freedom, such as exactly four, exactly five, or exactly six degrees of freedom. As parts of the arms 510a, 510b, the mobile robot 500 can include end effectors 514a, 514b at distalmost portions of the corresponding kinematic chains. Rotary joints similar to rotary joint 100 described with respect to FIG. 1 may be used on one or more joints associated with end effectors 514a and 514b, to measure a degree of rotation and an angular speed of the respective joints. Similarly, as parts of the legs 512a, 512b, the mobile robot 500 can include feet 516a, 516b at distalmost portions of the corresponding kinematic chains. Rotary joints similar to rotary joint 100 described with respect to FIG. 1 may be used on one or more joints associated with legs 512a and 512b, to measure a degree of rotation and an angular speed of the respective joints. Thus, the arms 510a, 510b and legs 512a, 512b can distally carry the end effectors 514a, 514b and the feet 516a, 516b, respectively. At the same time, all angular joint motions can be appropriately measured as inputs to a feedback control system that governs the motion of the mobile robot 500.

As will be appreciated, in other embodiments the mobile robot 500 can be implemented in the context of mobile robots with more than two arms and/or in the context of non-legged mobile robots. The described robots can be implemented in the context of moving objects such as totes, boxes, crates, non-packaged hard goods, irregularly shaped objects, etc. Furthermore, it should be understood, in general, that other methods, devices, and systems in addition to those disclosed herein are within the scope of the present technology. For example, methods, devices, and systems in accordance with embodiments of the present technology can have different and/or additional configurations, components, procedures, etc. than those disclosed herein. Moreover, methods, devices, and systems in accordance with embodiments of the present technology can be without one or more of the configurations, components, procedures, etc. disclosed herein without deviating from the present technology.

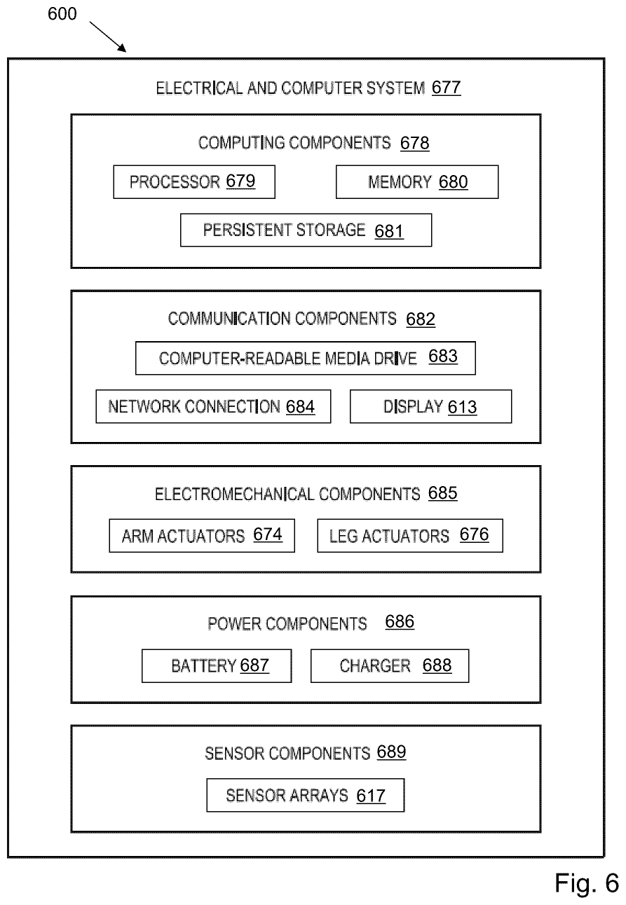

FIG. 6 is a block diagram 600 illustrating an electrical and computer system 677 of the mobile robot 500 illustrated in FIG. 5. When suitable, operations described elsewhere in this disclosure (e.g., movements of the mobile robot 500) can be implemented via this electrical and computer system 677 autonomously and/or in response to instructions from a user. Electrical and computer system 600 may also be used to process measurements generated by rotary joint 100 as described with respect to FIG. 1. As shown in FIG. 6, the electrical and computer system 677 can include computing components 678. The computing components 678 can include a processor 679, such as one or more general-purpose and/or special-purpose integrated circuits including digital logic gates for executing programs and/or for otherwise processing data. The computing components 678 can further include memory 680, such as one or more integrated circuits for storing data in use. The memory 680 can include a multithreaded program, an operating system including a kernel, device drivers, etc. The computing components 678 can further include persistent storage 681, such as a hard drive for persistently storing data. Examples of data that can be stored by the persistent storage 681 include diagnostic data, sensor data, configuration data, environmental data, and current-state data. The computing components 678 can collectively define a computer configured to manage, control, receive information from, deliver information to, and/or otherwise usefully interact with other components of the electrical and computer system 677.

The electrical and computer system 677 can further include communication components 682. The communication components 682 can include a computer-readable media drive 683 for reading computer programs and/or other data stored on computer-readable media. As one example, the computer-readable media drive 683 can be a flash-memory drive. The communication components 682 can further include a network connection 684 for connecting the mobile robot 500 to other devices and systems, such as other robots and/or other computer systems. The network connection 684 can be wired and/or wireless and can be via the Internet, a Local Area Network (LAN), a Wide Area Network (WAN), Bluetooth, WiFi, or a cell phone network. The network connection 684 can include networking hardware, such as routers, switches, transmitters, receivers, computer-readable transmission media, etc. The communication components 682 can further include the display 613 and/or other suitable components for communicating with a user. The mobile robot 500 can use the communication components 682 for internal operations and/or to interact with devices and/or systems external to the mobile robot 500, such as systems for providing contextual information about the environment in which the mobile robot 500 operates and/or systems for changing operating conditions of the mobile robot 500.

The electrical and computer system 677 can further include electromechanical components 685. The electromechanical components 685 can include the arm actuators 674 and the leg actuators 676 discussed above and/or other suitable components for implementing mechanical action within the mobile robot 500. The electrical and computer system 677 can further include power components 686. The power components 686 can include a battery 687 and a charger 688. The battery 687 can be a lithium-ion battery, a lead-acid battery, or another suitable type of battery. The charger 688 can include a connector (not shown) compatible with a power source (e.g., a wall outlet) and leads (also not shown) extending between the connector and the battery 687.

Finally, the electrical and computer system 677 can include sensor components 689 for capturing, providing, and/or analyzing information about the mobile robot 500 itself and/or the environment in which the mobile robot 500 is operating. The sensor components 689 can include the sensor arrays 617. At the sensor arrays 617 or at one or more other suitable locations, the mobile robot 500 can include among the sensor components 689 a light sensor (e.g., a photoresistor), a sound sensor (e.g., a microphone), an accelerometer, a gyroscope, a tilt sensor, a location sensor (e.g., using the Global Positioning System), a distance sensor, a contact sensor, and/or a proximity sensor, among other examples. The electro-optical wireless transceiver-based sensing described above for measuring joint rotation may also be included in sensor components 689. The mobile robot 500 can include one or more sensors in a sensor system, such as a vision system, a light detection and ranging (LIDAR) system, a sound navigation and ranging (SONAR) system, etc. In at least some cases, the mobile robot 500 monitors itself and/or its environment in real-time or in near real-time. Moreover, the mobile robot 500 may use acquired sensor data as a basis for decision-making via the computing components 678.

Components of the electrical and computer system 677 can be connected to one another and/or to other components of the mobile robot 500 via suitable conductors, transmitters, receivers, circuitry, etc. While the electrical and computer system 677 configured as described above may be used to support operation of the mobile robot 500, it should be appreciated that the mobile robot 500 may be operated using devices of various types and configurations and that such devices may have various components and levels of responsibility. For example, the mobile robot 500 may employ individual computer systems or controllers to manage discrete aspects of its operations, such as an individual computer system or controller to perform computer vision operations, a separate computer system or controller to perform power management, etc. In some cases, the mobile robot 500 employs the electrical and computer system 677 to control physical aspects of the mobile robot 500 according to one or more designated rules encoded in software. For example, these rules can include minimums and/or maximums, such as a maximum degree of rotation for a joint, a maximum speed at which a component is allowed to move, a maximum acceleration rate for one or more components, etc. The mobile robot 500 may include any number of mechanical aspects and associated rules, which may be based on or otherwise configured in accordance with the purpose of and/or functions performed by the mobile robot 500.

Software features of the mobile robot 500 may take the form of computer-executable instructions, such as program modules executable by the computing components 678. Generally, program modules include routines, programs, objects, components, data structures, and/or the like configured to perform particular tasks or to implement particular abstract data types and may be encrypted. Furthermore, the functionality of the program modules may be combined or distributed as desired in various examples. Moreover, control scripts may be implemented in any suitable manner, such as in C/C++ or Python. The functionality of the program modules may be combined or distributed in various embodiments, including cloud-based implementations, web applications, mobile applications for mobile devices, etc.

Furthermore, certain aspects of the present technology can be embodied in a special purpose computer or data processor, such as application-specific integrated circuits (ASIC), digital signal processors (DSP), field-programmable gate arrays (FPGA), graphics processing units (GPU), many core processors, etc. specifically programmed, configured, or constructed to perform one or more computer-executable instructions. While aspects of the present technology, such as certain functions, may be described as being performed on a single device, these aspects, when suitable, can also be practiced in distributed computing environments where functions or modules are shared among different processing devices linked through a communications network such as a Local Area Network (LAN), Wide Area Network (WAN), or the Internet. In a distributed computing environment, program modules and other components may be located in both local and remote memory storage and other devices, which may be in communication via one or more wired and/or wireless communication channels.

Aspects of the present technology may be stored or distributed on tangible computer-readable media, which can include volatile and/or non-volatile storage components, such as magnetically or optically readable computer media, hard-wired or preprogrammed chips (e.g., EEPROM semiconductor chips), nanotechnology memory, biological memory, or other computer-readable storage media. Alternatively, computer-implemented instructions, data structures, screen displays, and other data under aspects of the present technology may be distributed (encrypted or otherwise) over the Internet or over other networks (including wireless networks), on a propagated signal on a propagation medium (e.g., electromagnetic wave(s), sound wave, etc.) over a period of time, or they may be provided on any analog or digital network (packet switched, circuit switched, or other scheme). Furthermore, the term computer-readable storage medium does not encompass signals (e.g., propagating signals) or transitory media. One of ordinary skill in the art will recognize that various components of the mobile robot 500 may communicate via any number of wired and/or wireless communication techniques. Additionally, elements of the robot 500 may be distributed rather than located in a single monolithic entity. Accordingly, the disclosed systems and techniques may operate in one or more examples other than the examples provided above.

### Conclusion

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, in alternative embodiments the steps may have another suitable order. Similarly, certain aspects of the present technology disclosed in the context of particular embodiments can be combined or eliminated in other embodiments. Furthermore, while advantages associated with certain embodiments may be disclosed herein in the context of those embodiments, other embodiments may also exhibit such advantages, and not all embodiments need necessarily exhibit such advantages or other advantages disclosed herein to fall within the scope of the present technology. This disclosure and the associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Any reference herein to “the inventors” means at least one inventor of the present technology. As used herein, the terms “generally,” “substantially,” “about,” and similar terms are used as terms of approximation and not as terms of degree, and are intended to account for the inherent variations in measured or calculated values that would be recognized by those of ordinary skill in the art. Additionally, the terms “comprising,” “including,” “having,” and the like as used herein mean including at least the recited feature(s) such that any greater number of the same feature(s) and/or one or more additional types of features are not precluded. This is the case even if a particular number of features is specified unless that specified number is preceded by the word “exactly” or another clear indication that it is intended to be closed ended. In a particular example, “comprising two arms” means including at least two arms.

Directional terms, such as “upper,” “lower,” “front,” “back,” “vertical,” and “horizontal,” may be used herein to express and clarify the relationship between various structures. It should be understood that such terms do not denote absolute orientation. Reference herein to “one embodiment,” “an embodiment,” or similar phrases means that a particular feature, structure, or operation described in connection with such phrases can be included in at least one embodiment of the present technology. Thus, such phrases as used herein are not all referring to the same embodiment. Unless preceded with the word “conventional,” reference herein to “counterpart” devices, systems, methods, features, structures, or operations refers to devices, systems, methods, features, structures, or operations in accordance with at least some embodiments of the present technology that are similar to a described device, system, method, feature, structure, or operation in certain respects and different in other respects. Finally, it should be noted that various particular features, structures, and operations of the embodiments described herein may be combined in any suitable manner in additional embodiments in accordance with the present technology.

I/We claim:

1. A joint supporting electrical power connection and wireless communication comprising:
a first structure having an attached first wireless transceiver;
a second structure having an attached second wireless transceiver connectable with the first wireless transceiver;
at least one electrical contact positioned in a manner that physically connects the first and second structures to allow electrical power to be transferred between the first and second structures;
and wherein the first and second structures are movable with respect to each other.

2. The joint supporting electrical power connection and wireless communication of claim 1, further comprising:
a rotating bore attached to one of the first and second structures, with the first and second wireless transceivers respectively positioned to allow wireless transmission through the rotating bore.

3. The joint supporting electrical power connection and wireless communication of claim 1, wherein the at least one electrical contact further comprises a roll ring.

4. The joint supporting electrical power connection and wireless communication of claim 1, wherein the first and second wireless transceivers are RF transceivers.

5. The joint supporting electrical power connection and wireless communication of claim 1, wherein the first and second wireless transceivers are optical transceivers.

6. The joint supporting electrical power connection and wireless communication of claim 1, wherein the first and second wireless transceivers are RF transceivers that together act as position sensor by using RF measurements to determine relative angle between the first and second wireless transceivers.

7. The joint supporting electrical power connection and wireless communication of claim 1, wherein the first and second structures define at least a part of a robotic arm.

8. The joint supporting electrical power connection and wireless communication of claim 1, wherein the first and second structures define at least a part of a mobile humanoid robot.

9. A humanoid robot including a joint supporting wireless communication comprising:
a first structure having an attached first wireless transceiver;
a second structure having an attached second wireless transceiver connectable with the first wireless transceiver;
and wherein the first and second structures are movable with respect to each other and define a portion of a mobile humanoid robot.

10. The humanoid robot including a joint supporting wireless communication of claim 9, further comprising:
a rotating bore attached to one of the first and second structures, with the first and second wireless transceivers respectively positioned to allow wireless transmission through the rotating bore.

11. The humanoid robot including a joint supporting wireless communication of claim 9, wherein at least one electrical contact is positioned in a manner that physically connects the first and second structure to allow electrical power to be transferred between the first and second structures.

12. The humanoid robot including a joint supporting wireless communication of claim 9, wherein the first and second wireless transceivers are RF transceivers.

13. The humanoid robot including a joint supporting wireless communication of claim 9, wherein the first and second wireless transceivers are optical transceivers.

14. A rotary joint supporting electrical power connection and wireless communication comprising:
a first structure having an attached first wireless transceiver;
a second structure having an attached second wireless transceiver connectable with the first wireless transceiver;
at least one electrical contact positioned in a manner that physically connects the first and second structures to allow electrical power to be transferred between the first and second structures;
and wherein the first and second structures are rotatable with respect to each other.

15. The rotary joint supporting electrical power connection and wireless communication of claim 14, further comprising:
a rotating bore attached to one of the first and second structures, with the first and second wireless transceivers respectively positioned to allow wireless transmission through the rotating bore.

16. The rotary joint supporting electrical power connection and wireless communication of claim 14, wherein the at least one electrical contact further comprises a roll ring.

17. The rotary joint supporting electrical power connection and wireless communication of claim 14, wherein the first and second wireless transceivers are RF transceivers.

18. The rotary joint supporting electrical power connection and wireless communication of claim 14, wherein the first and second wireless transceivers are optical transceivers.

19. A method for determining rotational angle for a rotary joint supporting wireless RF communication, the method comprising:
associating first and second RF transceivers respectively positioned on mechanically connected first and second structures that can rotate relative to each other;
measuring RF signals as the first and second structures are rotated with respect to each other, and
determining rotational position based on measured RF signals.

20. The method for determining rotational angle for the rotary joint of claim 19, wherein a rotating bore is attached to one of the first and second structures, with the first and second wireless transceivers respectively positioned to direct RF signals through the rotating bore.
